(19) United States
(12) Patent Application Publication
(10) Pub. No.: US 2016/0121503 A1
(43) Pub. Date: May 5, 2016

(54) Acceleration Tube and Cutter Head Housing Retainer for Hydraulic Cutting System

(71) Applicant: Vanmark Equipment, LLC, Creston, IA (US)

(72) Inventor: Christopher Paul Hebbeln, Boise, ID (US)

(21) Appl. No.: 14/929,807

(22) Filed: Nov. 2, 2015

Related U.S. Application Data
(60) Provisional application No. 62/073,970, filed on Nov. 1, 2014.

(51) Int. Cl. B26D 7/06; B26D 1/02

(52) U.S. Cl. CPC B26D 7/0658; B26D 1/02

(57) ABSTRACT

An apparatus for a hydraulic cutting system having a pump that propels solid food products suspended in a working liquid through a blade. An elongated case is mounted in, and is longitudinally-movable relative to, a frame. The case has at least one rigid member connected to an upstream ring and extending to a downstream ring. A substantially flexible, tapered tube is mounted within, and substantially coaxially to, the case. At least a first portion of the case is moveable from a closed position, in which the tapered tube is retained in the case, to an opened position, in which the tapered tube may be removed from the case, relative to a second portion of the case.

### CROSS-REFERENCES TO RELATED APPLICATIONS

This application claims the benefit of U.S. Provisional Application No. 62/073,970 filed Nov. 1, 2014.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to hydraulically fed food cutting apparatuses, and more particularly to an apparatus that retains the acceleration tube and cutting head housing of a hydraulically fed food cutting apparatus.

Many food products, particularly vegetables and fruits, are processed prior to sale to preserve the food so it is safe and appealing at the time of consumption. Furthermore, unless they are in an edible size before processing, food products are sliced or otherwise shaped into an edible size during processing and prior to the preservation process, which can be canning or freezing, among others. Food product slicing is accomplished traditionally with sharpened blades. Such blades can be hand-held, but hand-held knives are relatively slow and dangerous to the person using them. Food cutting machines increase the rate and consistency of slicing, and provide a higher degree of safety in the food slicing industry. Machines have been developed for cutting food products at high speed by propelling them into a stationary or machine-driven blade.

Recent advances in food product cutting technologies have resulted in a hydraulically fed cutting apparatus. The driving force used in this system is moving water, and thus the process is called “hydraulic cutting”, which is referred to by the shorthand term “hydrocutting”. Hydrocutting involves the propulsion of water and food products, typically at very high speed, through a path that includes a stationary cutting blade. In the vegetable and fruit cutting industry, food products are sliced along the longitudinal axis (e.g., French fries) and along the transverse axis (e.g., potato chips). Production cutting systems and related knife fixtures are generally well known in the art of hydrocutting vegetable products. Typical hydrocutting systems have a stationary knife fixture that is mounted at a position along the path of the food product to slice parallel to the flow of water. Such parallel cutters usually cut or slice into strips or, with added motions, into a helical shape. In such a system, the food products are conveyed one-at-a-time in single file succession into the stationary cutting blades with enough kinetic energy to carry the product through the stationary knife fixture.

Hydraulic food cutters are used to cut a wide variety of food products, including potatoes, carrots, beets, zucchini, cucumbers, and others. Cutting potatoes has been the most common application of hydrocutting machines, but it should be understood that hydraulic food cutters are capable of cutting, and are used to cut, a wide variety of food products.

The basic configuration of a conventional hydrocutting system is shown, in schematic format, in FIG. 1. In a typical hydraulic cutting apparatus where potatoes are to be cut, the potatoes are placed in a tank 10 filled with water and then pumped through conduit into an alignment chute or accelerator tube 14 wherein the potatoes are aligned and accelerated to high speed before impinging upon a fixed array of cutter blades where the potato is cut into a plurality of smaller pieces.

Peeled or unpeeled potatoes are dropped into the receiving tank 10 and a food pump 12, typically a single impeller centrifugal pump, is provided to drive the water and potatoes through the system. The pump draws water from the receiving tank and pumps the water and the suspended potatoes from the tank into the accelerator tube 14, which functions as the converging portion of a venturi. The accelerator tube 14 is used to accelerate, singulate, and align the potatoes immediately prior to impinging upon the stationary knife blades of the cutter blade assembly 16.

As noted above, the water and the food product are pumped through a decreasing diameter accelerating section conduit in order to increase the speed of the food products and water as they approach the blade. Unless otherwise specified, the term “acceleration” and its derivatives are used herein to denote both positive and negative (increasing and decreasing) changes of velocity per unit time. The water and food products increase in speed, orient, and align as they pass through the accelerating section. The accelerating section also singulates the food products, meaning the food products travelling through conduit laterally beside one another are arranged in a “single file” line before each item passes through the cutter head. In FIG. 1, the cutter head is in the cutter blade assembly 16, and the cutter blade assembly is removable for service, change of cutting pattern and/or replacement.

The accelerator tube performs at least three functions. First, the accelerator tube accelerates the water and food product to the velocity required for the combination to pass cleanly and completely through the knife blade assembly. In the case of potatoes, a common velocity range is from about 40 to about 60 feet per second. Second, the accelerator tube aligns and centers each of the food products prior to impingement upon the knife blade assembly. Third, the acceleration of the product causes laterally-aligned products to separate and align longitudinally, thereby entering the cutter in a “single file” line.

Potatoes can be cut into French fry sticks as one example of the use of hydrocutting systems, and this will be used as an example hereafter. A person of ordinary skill will understand, after reading the description herein, how to adapt the apparatus described to other food products. Each whole potato impinging upon the knife blade assembly at high speed passes through the cutting blade array and is thereby cut into a plurality of food pieces, for example French fry pieces. The cross section of each of the food strips is determined by the arrangement of the cutter head knives.

A portion of the hydrocutting system separates the food product strips from the water once the strips are past the cutter head. It is desirable to slow down the water column and the food product strips in a controlled manner before this separation portion is encountered. This is because the strips may be fragile (depending on the food product) and gentle handling in the sections following cutting prevents breakage of, or stress on, the strips that would render the strips less desirable. The food strips thus pass with the water into the second half of the venturi which is a diverging tube 18 in which the water and the cut food pieces are decelerated back to a slower velocity. The water and cut food pieces are then deposited onto a dewatering conveyer 20. The water passes through the dewatering conveyor and is collected and recycled back to the receiving tank via a water return line 22. The cut food pieces remain on the conveyor 20 and are carried off for further processing. U.S. Pat. No. 5,568,755, U.S. Pat. No. 5,806,397, and U.S. Pat. No. 4,614,141 are hereby incorporated by reference.

It is conventional for the alignment (accelerator) tube to be a two-part assembly consisting of a converging, conically-shaped metal or other rigid material housing, into which is inserted a more resilient liner, which liner is usually formed of reinforced food grade rubber that seats against the inner surface of the rigid housing. Furthermore, the larger inlet end of the tapered housing is hard-plumbed to the discharge line of the centrifugal pump.

Usually this is a bolted connection between a flange on the discharge line and a flange formed integrally to the input end of the tapered housing.

At the outlet end of the tapered accelerator housing, the resilient liner usually extends out a few inches and this protruding portion is inserted into the inlet hole of the cutter blade housing. In some prior art designs the outlet of the accelerator tube liner (the tip of the protruding portion) ends immediately in front of the knife blade array. A water seal between the cutter blade housing and the accelerator tube assembly can be made by hard-plumbing the accelerator tube housing to the cutter blade housing. However, hard plumbing is not found in all designs because it is too difficult and time-consuming to remove the housing for repair and maintenance.

Since the interface region between the accelerator tube assembly and the cutter blade housing is the narrowest part of the venturi, the hydraulic pressure at that point in the system is greatly increased from that found at the discharge of the pump, usually in the range of two to ten pounds per square inch. Instead of hard plumbing the outlet of the accelerator tube assembly to the inlet of the cutter blade housing, multiple packing rings are used. This is to reduce the time required to disassemble and remove the accelerator tube assembly from the system. Each time the outlet end of the accelerator tube liner is removed from the inlet of the cutter blade housing, the packing rings should be replaced.

Accelerator tube assemblies must be periodically disassembled for many reasons that include cleaning, replacement of worn out liners, replacement of the liner with a different size liner, and cleaning out a “plug” of uncut food product that has blocked the tube. All but the last are usually handled as scheduled maintenance items, and the time requirements, while significant, are not critical. The unscheduled and unwanted plug-up of the system is a problem because it often results in a complete shutdown of a production line without prior notice.

In the case of potatoes, production rates for hydraulic cutting systems are typically between 20,000 to 35,000 pounds per hour. At a cutting rate of 20,000 pounds per hour, and assuming an average potato weight of ten ounces, the number of potatoes passing through the cutter blade assembly is approximately 32,000 potatoes per hour, or approximately 8.8 potatoes per second. If one potato plugs the cutter blade assembly, in 10 seconds there will be 88 potatoes backed up behind the cutter housing in the accelerator tube assembly; in 20 seconds, 176 potatoes. At 35,000 pounds per hour the problem is further aggravated. In practice, if a prior art hydraulic cutting apparatus plugs while unattended, it is not uncommon for the plug to include potatoes backed up into the food pump. A plug such as this can take hours to clean out since it requires substantial disassembly of the machine and its attendant piping. As a result, it is common practice in food processing plants to provide operating personnel to continuously monitor the operation of the hydro-cutting system.

The need exists for an acceleration tube and blade housing that can be removed, replaced and cleaned with low effort and in little time.

### BRIEF SUMMARY OF THE INVENTION

Disclosed herein is a hydraulic cutting system having a pump that propels solid food products suspended in liquid through a flexible, tapered tube and a blade. A rigid frame is configured to receive a cutter head housing which contains the blade, and the liquid and suspended food products are pumped through the tapered tube, which accelerates the suspension, and then the blade, which cuts the solid food products.

An elongated case is mounted in, and is longitudinally-displaceable relative to, the rigid frame. The case has at least rigid members, which may be first, second and third rigid elongated members, extending from an upstream ring to a downstream ring. The upstream ring preferably includes at least a first portion that is longitudinally displaceable relative to the frame, a second portion that is displaceable relative to the first portion, and a third portion that is displaceable relative to the first portion. With the first rigid member mounted to the first ring portion, the second rigid member mounted to the second ring portion, and the third rigid member mounted to the third ring portion, the members and corresponding rings are moveable to retain, in a closed position, and permit removal, in an opened position, of the tapered tube.

The downstream ring preferably includes a first portion that is longitudinally displaceable relative to the frame, a second portion that is displaceable relative to the first portion, and a third portion that is displaceable relative to the first portion. As with the upstream ring, the first rigid member is mounted to the first ring portion, the second rigid member is mounted to the second ring portion, and the third rigid member is mounted to the third ring portion. Thus, the members and corresponding rings are moveable to retain, in the closed position, and permit removal, in the opened position, of the tapered tube.

The tapered tube is mounted within, and substantially coaxially to, the case. The tapered tube may have a downstream flange against which the downstream ring seats to form a seal and an upstream flange against which the upstream ring seats to form a seal. A compression plate may be mounted, and longitudinally-moveable relative, to the frame and may be drivingly linked to the upstream ring. At least one prime mover is mounted to the frame and the compression plate for displacing the compression plate, and the case, longitudinally.

In a preferred embodiment, the first and second members and the first and second portions of each ring pivot from a closed position, in which the tapered tube is retained in the case, and an opened position in which the tapered tube is removable from the case.

In a preferred embodiment, the tapered tube has a downstream flange against which the downstream ring seats, when the downstream flange is compressed against an upstream face of a longitudinally-moveable seal transfer plate mounted in the frame, to form a seal. The improved tapered tube preferably has an upstream flange against which the upstream ring seats when compressed against the compression plate to form a seal.

### BRIEF DESCRIPTION OF THE SEVERAL VIEWS OF THE DRAWINGS

FIG. 1 is a schematic illustration of a prior art hydraulic cutting system.

FIG. 2 is a front view illustrating a preferred embodiment of the present invention.

FIG. 3 is a top view illustrating the embodiment of FIG. 2.

FIG. 4 is an end view illustrating the outlet end of the embodiment of FIG. 2.

FIG. 5 is an end view illustrating the inlet end of the embodiment of FIG. 2.

FIG. 6 is a view in perspective illustrating the embodiment of FIG. 2 with the safety shield opened.

FIG. 7 is another view in perspective illustrating the embodiment of FIG. 2 with the safety shield opened.

FIG. 8 is a front partial enlarged view illustrating the embodiment of FIG. 2 in the closed position.

FIG. 9 is an enlarged view in perspective illustrating the configuration of FIG. 8.

FIG. 10 is a front partial enlarged view illustrating the embodiment of FIG. 2 in the opened position.

FIG. 11 is an enlarged view in perspective illustrating the configuration of FIG. 10.

FIG. 12 is front view illustrating the embodiment of FIG. 2 in the opened position.

FIG. 13 is a front view in section illustrating the embodiment of FIG. 7 through the line 13-13.

FIG. 14 is an enlarged view in perspective illustrating the embodiment of FIG. 6 in the opened position.

FIG. 15 is an enlarged view in perspective illustrating the embodiment of FIG. 7 in the opened position.

FIG. 16 is an enlarged view in perspective illustrating the embodiment of FIG. 7.

FIG. 17 is an enlarged side view in section illustrating the embodiment of FIG. 6 through the line 17-17.

FIG. 18 is a view in perspective illustrating an enlarged cutter housing zone of the embodiment of FIG. 2.

FIG. 19 is a view in perspective illustrating the embodiment shown in FIG. 18 with the cutter head housing in an operable position.

FIG. 20 is a view in perspective illustrating the embodiment shown in FIG. 18 with the cutter head housing in a first position laterally of the operable position.

FIG. 21 is a view in perspective illustrating the embodiment shown in FIG. 18 with the cutter head housing in second position lateral of the first position.

FIG. 22 is a view in perspective illustrating the embodiment shown in FIG. 18 with the cutter head housing in third position similar to the second position but with the handles rotated upwardly.

FIG. 23 is a side view in section illustrating an alternative hydrotube.

FIG. 24 is a view in perspective illustrating the alternative hydrotube of FIG. 23.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application Ser. No. 62/073,970 and U.S. Non-provisional application Ser. No. 14/147,657 are incorporated in this application by reference.

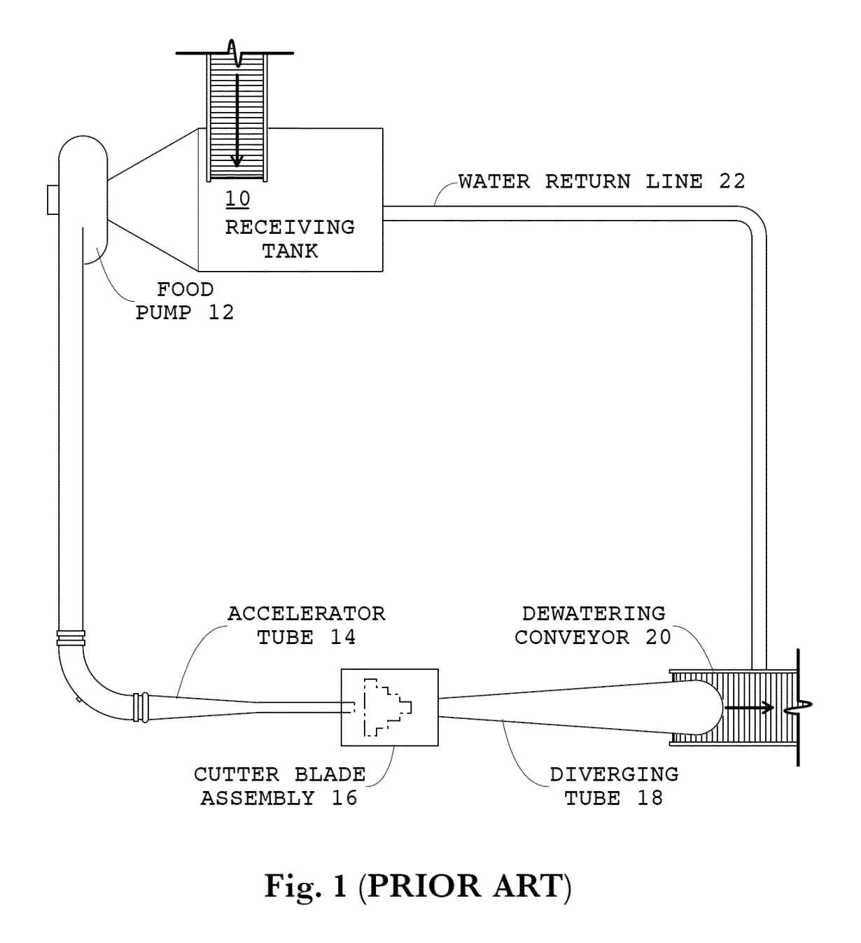

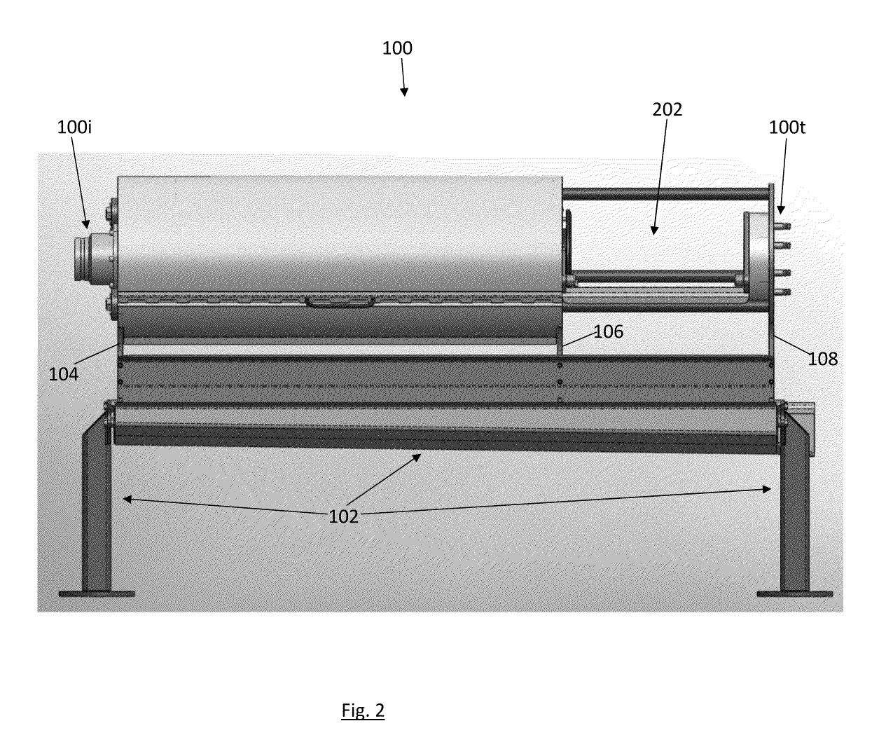

The apparatus 100 shown in FIG. 2 includes a frame 102 that rests upon a horizontal surface, which may be the concrete floor of a facility where the apparatus 100 is used. The frame 102 may be made of stainless steel, such as square tubing welded together, to form a rigid foundation to which other structures of the apparatus 100 may mount. Unless otherwise noted, the structures of the apparatus 100 are made of low carbon steel or stainless steel, but it will be understood by the person of ordinary skill that food processing regulations or engineering principles may permit or require the use of an equivalent material such as aluminum, plastic or a composite. Typically, food grade material is preferred. The frame 102 may have feet, wheels or some other structure that engages the surface upon which it rests. It is contemplated that, in an example, the apparatus 100 may be used in a conventional hydrocutting system in place of the cutter blade assembly 16 and accelerator tube 14 shown schematically in the system of FIG. 1, as will be understood from the description below. In this example, water (or another working liquid) and suspended solid food pieces are pumped into the inlet end 100i and food product slices and water flow out of the outlet end 100t.

Three plates 104, 106 and 108 mount rigidly to the frame 102 spaced from one another, and, in the orientation of FIG. 2, are substantially parallel and vertically-oriented. The plates 104-108, along with the frame 102, may be welded, bolted, or otherwise joined together to form a body that is substantially rigid. Under the forces encountered by, and within, the apparatus 100 during normal operation, the plates 104-108 are not substantially bent or otherwise displaced relative to one another, nor are any other frame 102 members. Thus, the apparatus 100 has a stable and rigid foundation.

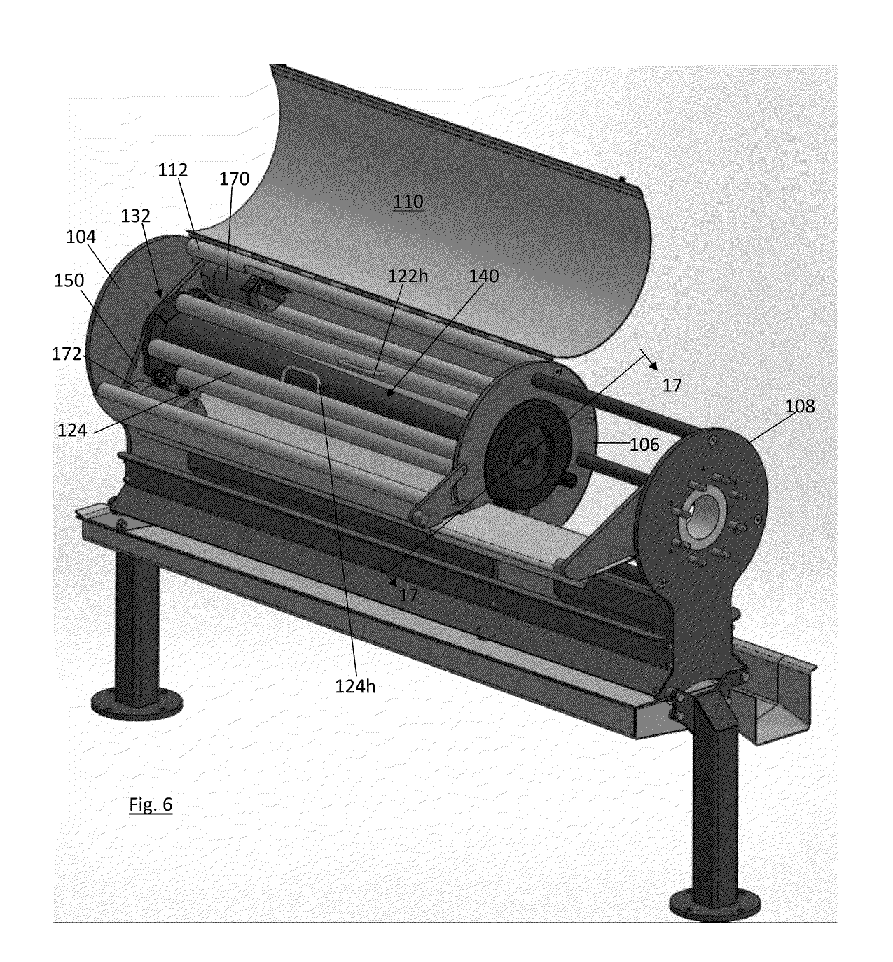

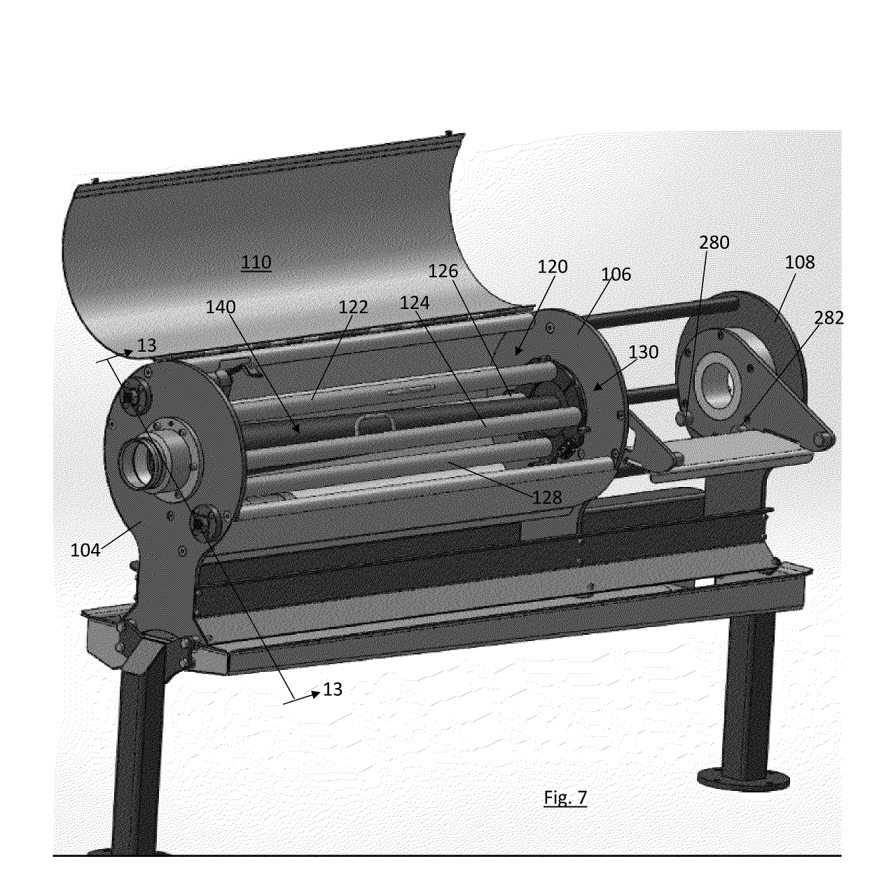

As shown in FIGS. 6, and 7, a safety shield 110 is hingedly mounted to a rod 112 that rigidly connects to the plates 104 and 106. The shield 110 pivots from a closed position shown in FIGS. 2 and 3 to an opened position shown in FIGS. 6 and 7. When the shield 110 is in the closed position, a conventional switch (not visible) is engaged, and in this condition the apparatus 100 may operate as described below. When the shield is in any position other than the closed position, such as the opened position, the apparatus 100 is prevented from operating as described below, and this is due to conventional safety features incorporated into the apparatus 100 to protect the operator of the apparatus 100 and anyone who may maintain it. Regardless of the foregoing, for illustrative purposes the apparatus 100 may be shown or described herein operating according to the invention even though the shield 110 may be removed or placed in the opened position.

A hydrotube case 120 (FIG. 7) is mounted between the plates 104 and 106, and may include four substantially rigid, preferably elongated tubular steel members, which may be the bars 122, 124, 126 and 128 rigidly mounted at opposite longitudinal ends to the hydrotube case rings 130 and 132. The case 120 includes at least one rigid member mounted to the rings at opposite ends, and the bars may be replaced by one or more beams or other structural members. The case 120 is elongated and is aligned along the longitudinal axis of the apparatus 100 so that it captures and retains the hydrotube 140 during operation, but permits the hydrotube 140 to be replaced conveniently. The case 120 is designed, as described in more detail below, to move longitudinally within the hydrotube zone that is formed between the plates 104 and 106 and within the housing of which the shield 110 is a component. This longitudinal movement is possible due to the structure by which the case 120 mounts to the plates 104 and 106.

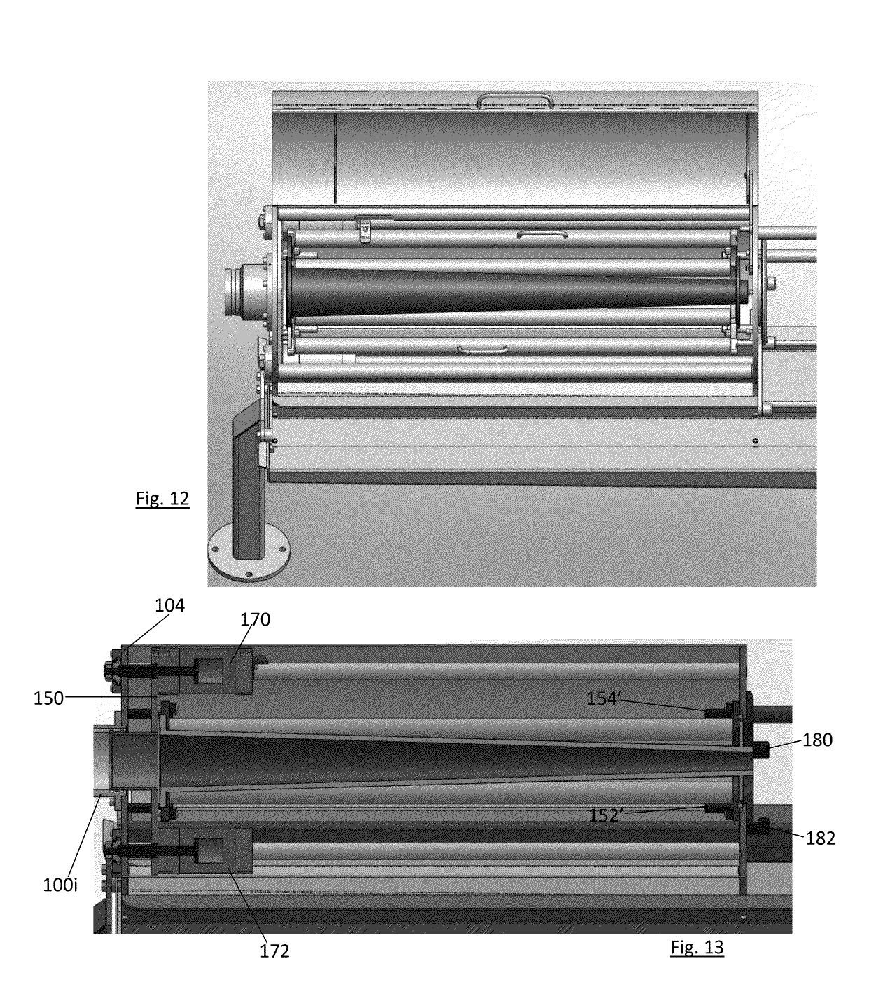

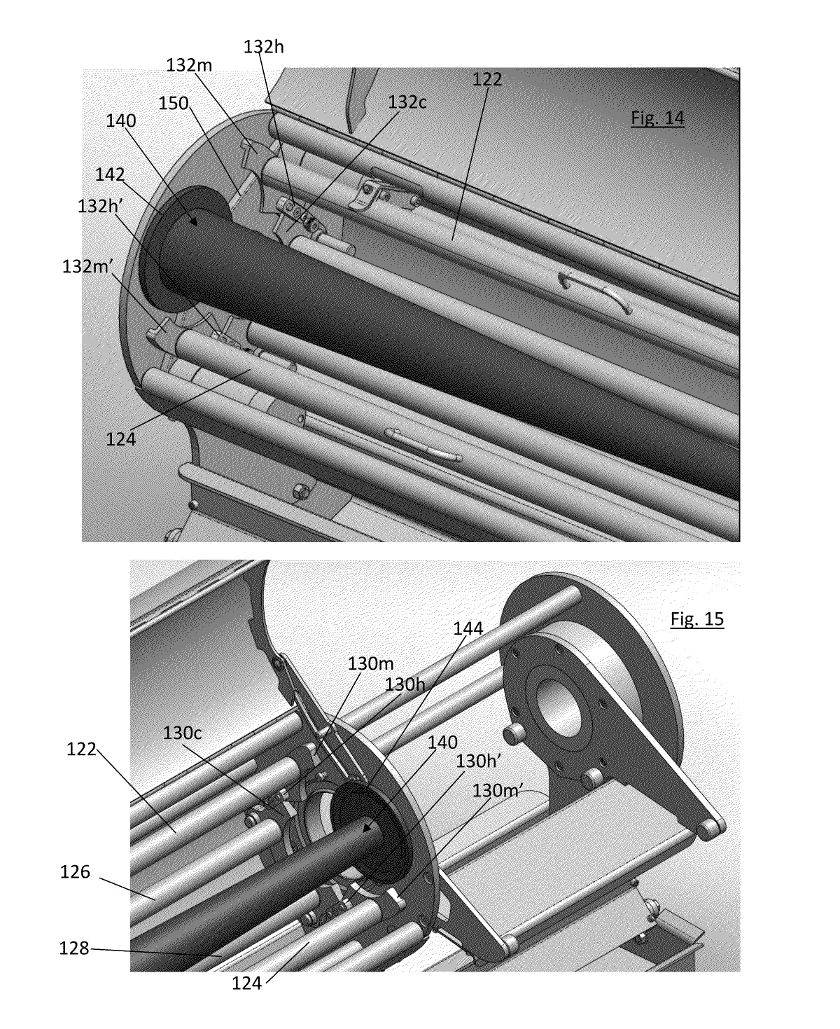

The hydrotube 140 (FIGS. 12 and 13) has an upstream end with a larger diameter and tapers to a narrower, downstream end. The downstream flange 144 is adjacent the downstream end, and the upstream flange 142 is adjacent the upstream end of the hydrotube 140. The hydrotube 140 is made of substantially flexible material, which may be rubber, urethane, or a substantial equivalent. The hydrotube 140 receives water and food product pieces through its connection with the inlet 100i, which extends sealingly and slidably into the upstream end of the hydrotube 140. The suspension is accelerated, in the manner of an accelerator tube, due to the hydrotube's tapered shape, which is known in the hydrocutting art. The hydrotube 140 sealingly mounts to the cutter head housing 200, as described below, which housing 200 sealingly mounts to the outlet end 100t.

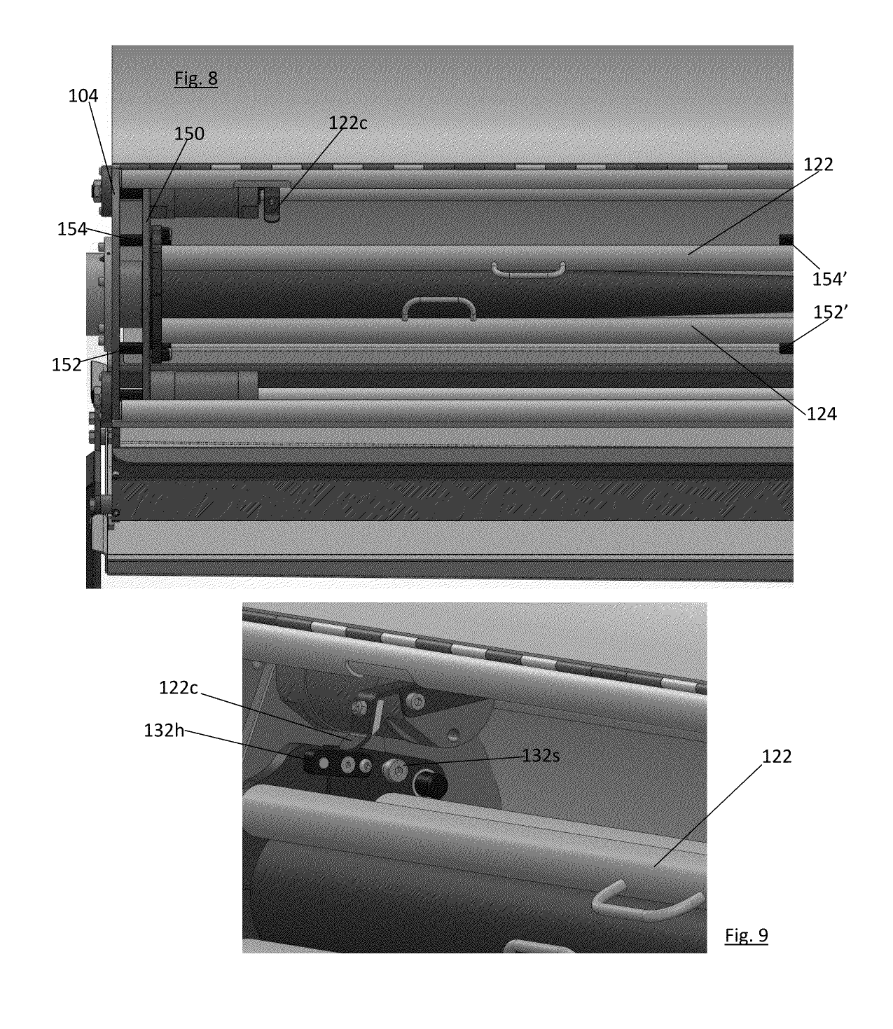

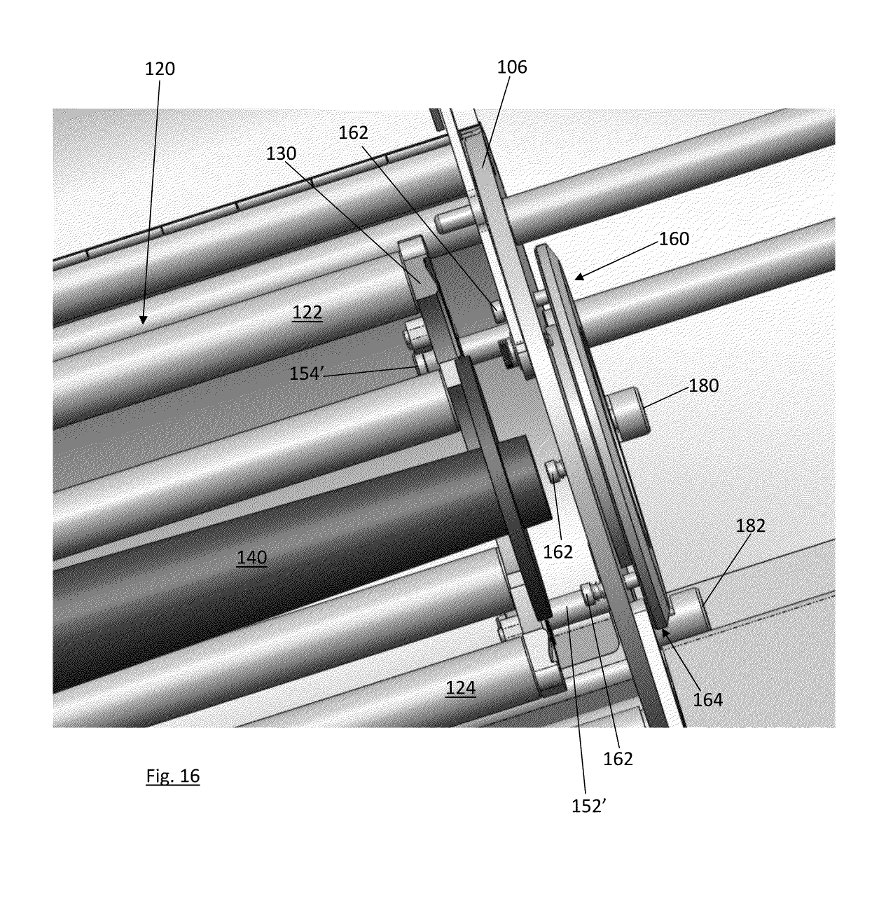

The bars 126 and 128 are mounted rigidly to C-shaped ring portions 130c and 132c (FIGS. 14 and 15), which may be longitudinally-movably mounted to the plates 104 and 106, either directly or through other structures. The C-shaped ring portions 130c and 132c may be slidably mounted to the pins 152, 152′, 154 and 154′ (FIG. 8), which are rigidly mounted to the plates 104 and 106. The bars 126 and 128 are positioned behind and below, respectively, the hydrotube 140 as viewed in FIGS. 6 and 7.

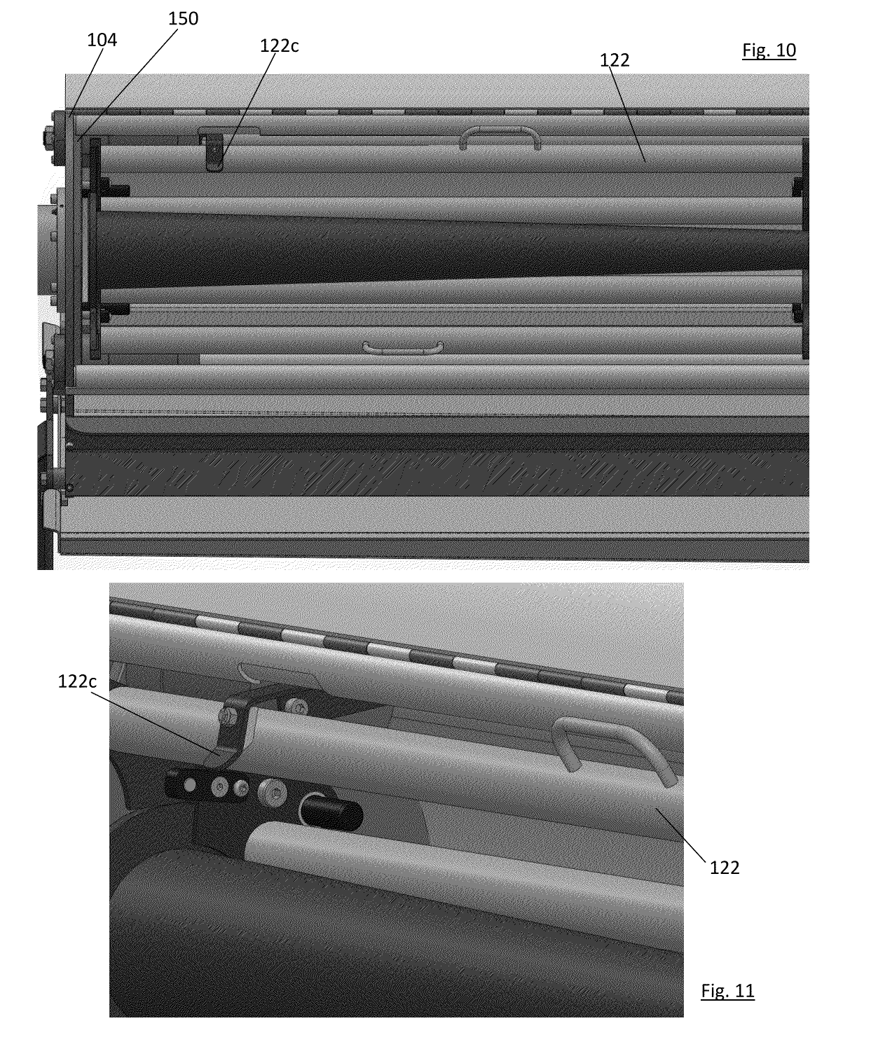

The bar 122 mounts rigidly to the pivotable ring portions 130m and 132m, as shown in more detail in FIGS. 14 and 15. The bar 124 mounts rigidly to the pivotable ring portions 130m′ and 132m′. The pivotable ring portions 130m and 130m′ are pivotably mounted to opposite ends of the respective C-shaped ring portion 130c. The pivotable ring portions 132m and 132m′ are mounted to opposite ends of the respective C-shaped ring portion 132c. As shown in FIG. 14, the pivotable ring portions 132m and 132m′ at the upstream end of the bars 122 and 124 have hinge portions 132h and 132h′ that mount to the respective ring portions to permit the pivotable ring portions to pivot relative to the C-shaped ring portion. The terms “upstream” and “downstream” refer to the direction of product flow through the apparatus 100 during normal operation. As shown in FIG. 15, the pivotable ring portions 130m and 130m′ at the downstream end of the bars 122 and 124 have hinge portions 130h and 130h′ that mount to the respective ring portions to permit the pivotable ring portions to pivot relative to the C-shaped ring portion. Thus the C-shaped ring portions 130c and 132c remain mounted to the plates 104 and 106 while the pivotable ring portions 130m, 130m′, 132m and 132m′ may pivot relative to the C-shaped ring portions 130c and 132c, and therefore the plates 104 and 106 and the bars 126 and 128. The bars 122 and 124 can thus be pivoted from closed positions, shown in FIGS. 6, 7, 8 and 9 and where the hydrotube 140 cannot be removed, to opened positions, shown in FIGS. 10, 11 and 12, where the hydrotube 140 can be removed and/or inserted. The bars 122 and 124 can be pivoted between the opened and closed positions relative to the plates 104 and 106 without movement of the C-shaped ring portions 130c and 132c and the bars 126 and 128.

The bars 122 and 124 are shown in their closed positions in FIGS. 6-9, and the closed position is defined as the position of each of the bars 122 and 124 close to the hydrotube 140 where the pivotable ring portions 130m, 130m′, 132m and 132m′ prevent the hydrotube 140 from being removed from the case 120. The bars 122 and 124 are shown in FIGS. 10, 11 and 12 pivoted outwardly from the hydrotube 140 with their corresponding pivotable ring portions also pivoted to their opened positions, and the opened position is defined as the position of each of the bars 122 and 124 far from the hydrotube 140 where the pivotable ring portions 130m, 130m′, 132m and 132m′ permit the hydrotube 140 to be removed from, and/or inserted into, the case 120. In order to pivot from the closed positions to the opened positions, the bars 122 and 124 must follow an arcuate path dictated by the connection between the pivotable ring portions and the C-shaped ring portions.

When the bar 122 is in the closed position shown in FIG. 8, the bar catch 122c, which is mounted to a stable structure adjacent the bar 122, is not used. When the bar 122 is in the opened position as shown in FIG. 10, the bar catch 122c may receive the bar 122 and retain the bar 122 in the opened position despite the effect of gravity tending to force the bar 122 downwardly back to the closed position. The bar catch 122c has a U-shaped opening that faces the bar 122 and may have a high-friction pad against which the bar 122 rests when in the opened position. When the bar 122 is raised upwardly from the closed to the opened position, the bar 122 is inserted into the U-shaped opening and rests against the high-friction pad, which exerts a sufficient force to retain the bar 122 until the bar 122 is manually pushed downwardly by the operator. The catch 122c thereby avoids the need for the user to manually hold the bar 122 against the force of gravity urging it toward the closed position by providing a convenient retainer for the bar 122 in the opened position. A person can thus grasp the handles 122h and 124h (see FIG. 6) and pivot the bars 122 and 124 to the opened position in order to remove and/or replace the hydrotube 140. When opened, the bar 124 remains open because the force of gravity tends to maintain the bar 124 in the opened position. However, the bar 122 may not otherwise remain open due to the force of gravity tending to urge the bar 122 to the closed position. Nevertheless, the catch 122c may retain the bar 122 in the opened position until the operator manually removes the bar 122 therefrom.

A compression plate 150 is longitudinally slidably mounted to the plate 104 upstream of the ring 132 as shown in FIGS. 6 and 8. In the orientation of FIG. 6, product flows from the left to the right through the apparatus 100, and this corresponds to the longitudinal axis of the apparatus 100. The pins 152 and 154 extend longitudinally downstream from rigid attachment to the plate 104 (see FIGS. 5 and 8) at their upstream ends and have free downstream ends opposite the plate 104 to form cantilevers extending toward the plate 106 a distance that may be about three to five inches and is preferably less than the length of the bars 126 and 128.

The compression plate 150 is slidably mounted along the pins 152 and 154 and may be displaced longitudinally between substantially seating against the plate 104 (FIG. 10) at one extreme to the ends of the pins 152 and 154 (FIG. 13) at another extreme as driven by a pair of linear prime movers, which may be the pneumatic rams 170 and 172. The cylinder housings of the rams 170 and 172 may mount to the compression plate 150 and the piston shafts of the rams 170 and 172 may mount to the plate 104, as best viewed in FIGS. 6 and 13. Upon actuation of the longitudinally-driven rams 170 and 172 in one direction, the compression plate 150 is displaced longitudinally downstream, and upon actuation of the rams 170 and 172 in the opposite direction, the compression plate 150 is displaced longitudinally upstream. Of course, the pneumatic rams 170 and 172 can be replaced by any prime movers, including without limitation servo motors, linear motors, hydraulic rams and all equivalents.

Adjacent the compression plate 150, the ring 132 is also longitudinally slidably mounted to the plate 104 by the pins 152 and 154 extending slidably through the ring 132. The ring 132 slides along the pins 152 and 154 between substantially seating against the compression plate 150 at one extreme and the ends of the pins 152 and 154. The pneumatic rams 170 and 172 drive the compression plate 150, and the compression plate 150 may be drivingly linked to the ring 132. A shoulder bolt 132s (FIG. 9) may extend slidably through the C-shaped ring portion 132c and thread into the compression plate 150. The bolt 132s has a head that defines a limit for how far the ring 132 can be spaced from the compression plate 150, and by threading the bolt 132s in and out of the compression plate 150, the operator may make adjustments to the distance the ring 132 may be spaced from the compression plate 150. This distance corresponds to the maximum gap formed between the upstream face of the ring 132 and the downstream face of the compression plate 150, which is a gap in which an upstream flange 142 of the hydrotube 140 may be inserted.

The pins 152′ and 154′ extend longitudinally upstream from rigid attachment to the plate 106 (see FIGS. 8 and 13) at their downstream ends and have free upstream ends to form cantilevers extending upstream toward the plate 104 a distance that may be about three to five inches and is less than the length of the bars 126 and 128. The ring 130 is longitudinally slidably mounted to the seal transfer plate 106 by mounting to the longitudinal pins 152′ and 154′. The ring 130 slides along the pins 152′ and 154′ between the ends of the pins 152′ and 154′ and substantially seating against the seal transfer plate 106.

Because the rods 122, 124, 126 and 128 are rigidly mounted on their upstream end to the ring 132, which may be driven longitudinally by the pneumatic rams 170 and 172, and on their downstream ends to the ring 130, the ring 130 may be displaced downstream by the pneumatic rams 170 and 172. Thus, the pneumatic rams 170 and 172 may longitudinally displace the compression plate 150, along with the entire hydrotube case 120, from one extreme upstream position (shown in FIG. 12) to an extreme downstream position (shown in

FIG. 13) and back to the extreme upstream position.

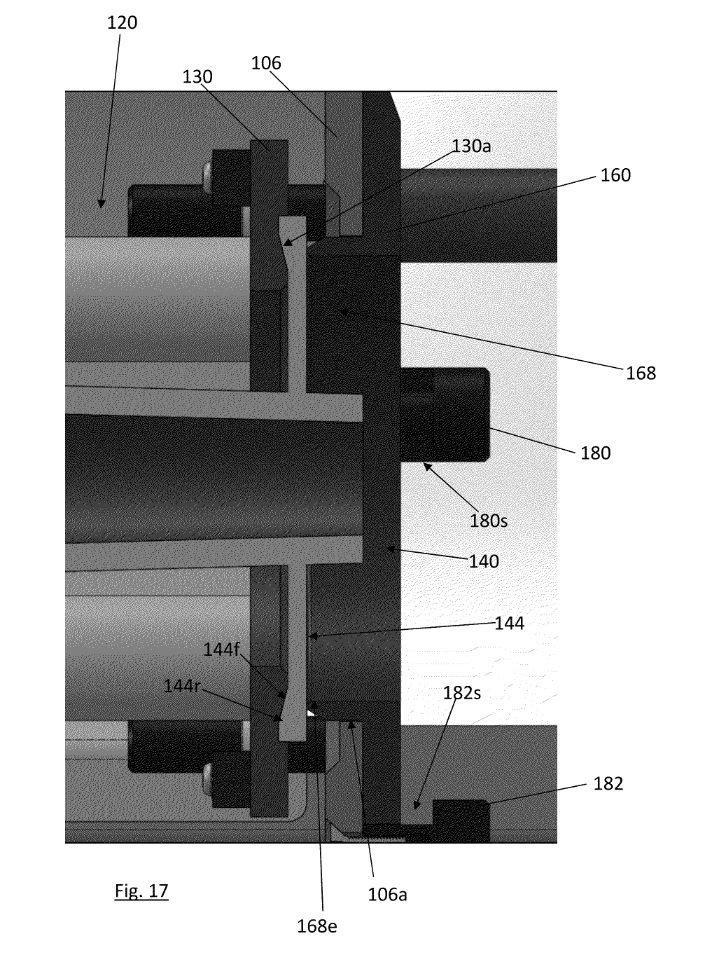

The seal transfer plate 160 is a preferably circular disk with a longitudinal annulus 168 extending upstream toward the hydrotube 140, as shown in the sectional view of FIG. 17. The seal transfer plate 160 is longitudinally slidably mounted to the plate 106 near the downstream end of the case 120, as shown in FIGS. 16 and 17. Three bolts 162 may extend slidably through the plate 106 and mount rigidly in the seal transfer plate 160. This configuration may thereby limit the seal transfer plate's 160 longitudinal range of movement to between the bolts' 162 heads and the upstream face of the seal transfer plate 160. The range could be further or otherwise limited. Coil springs may be mounted between the plate 106 and the heads of the bolts 162 to bias the seal transfer plate 160 upstream toward the plate 106.

The annulus 168 of the seal transfer plate 160 extends upstream through an aperture formed in the plate 106 that is defined by the shoulder 106a and terminates in a sharp, upstream-directed edge 168e. In the configuration shown in FIG. 17, the upstream-directed edge 168e may seat against the downstream face of the flange 144 of the hydrotube 140. The seal transfer plate 160 may move longitudinally between one extreme upstream position shown in FIG. 17 and an extreme downstream position shown in FIG. 16. The flange 144 may be compressed between the upstream-directed edge 168e of the annulus 168 and the downstream face of the ring 130.

The cutter head housing guide pins 180 and 182 mount rigidly to the plate 106 and extend longitudinally downstream as cantilevers toward the plate 108 a distance that may be about one inch but could be more or less. The pins 180 and 182 have circumferential slots 180s and 182s formed therein (FIGS. 16 and 17) that accommodate the lip 164 of the seal transfer plate 160, which extends radially into the slots 180s and 182s. The downstream shoulders formed by the slots 180s and 182s may create a longitudinal limit to movement of the seal transfer plate 160, and may thereby prevent downstream movement of the lip 164 of the seal transfer plate 160 beyond the shoulders.

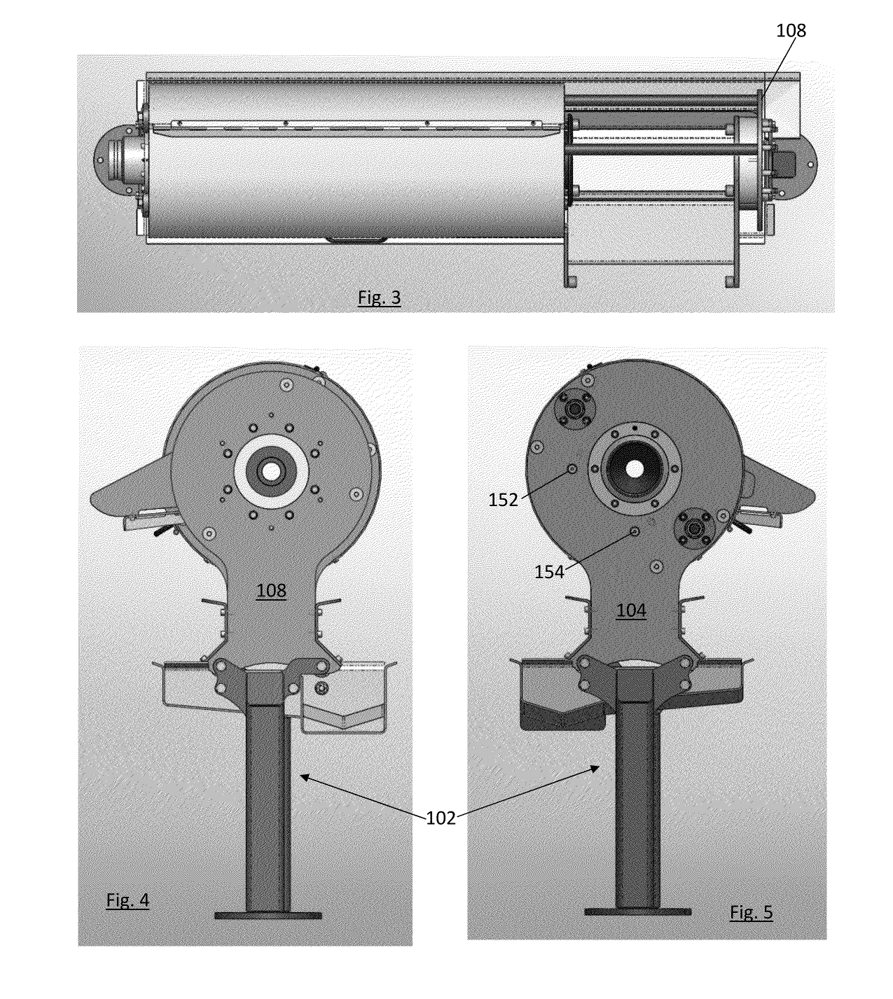

The pins 180 and 182 are positioned around the circular opening of the seal transfer plate 160, preferably at about the four and eight o'clock positions when viewed from the perspective of FIG. 4. The pins 180 and 182 may be positioned along lines that extend about 45 degrees from, and on opposite sides of, a vertical line extending radially through the six and twelve o'clock positions around the opening of the seal transfer plate 160. This positioning allows a circular-sided object, such as the cutter head housing 200 described below, to rest one rounded side on the pins 180 and 182, and that rounded side may align a central longitudinal passage in the housing 200 with the opening in the seal transfer plate 160.

Two downstream cutter head guide pins 280 and 282 are mounted to the plate 108, as shown in FIG. 7, either directly or through other structures that are mounted to the plate 108. The guide pins 280 and 282 extend longitudinally upstream and align coaxially with the downstream-directed guide pins 180 and 182. The pins 280 and 282 are positioned around the circular opening of the outlet plate 260, preferably at about the four and eight o'clock positions when viewed from the perspective of FIG. 4. The pins 280 and 282 may be positioned along lines that extend about 45 degrees from, and on opposite sides of, a vertical line extending radially through the six and twelve o'clock positions around the opening of the outlet plate 260. This positioning allows a circular-sided object, such as the cutter head housing 200 described below, to rest one rounded side on the pins 280 and 282, and that rounded side may align a central longitudinal passage in the housing 200 with the opening in the outlet plate 260. The combination of the guide pins 180, 182, 280 and 282 forms a cutter head housing alignment cradle, with the pins 180 and 182 receiving one end of the cutter head housing 200, and the pins 280 and 282 receiving the opposite end of the cutter head housing 200.

The cutter head housing 200 is mounted between the plates 106 and 108 in the cutter head housing zone 202 that is shown in FIG. 2. Although the housing 200 is not shown in the zone 202 in FIG. 2, the housing 200 may be manually placed there and removed therefrom with little effort on the part of the operator of the apparatus 100, as shown in FIGS. 19-22 and described further below. The housing 200 is a conventional cutter head housing with a central longitudinal passage therethrough and a blade, which is referred to as the “cutter head”, mounted across that passage. Food products, such as potatoes suspended in water, may be conveyed through the hydrotube 140 and then through the longitudinal passage of the cutter head housing 200 at high speed to cut the product into pieces as determined by the shape of the cutter head. The housing 200 is positioned in FIG. 19 with its rounded ends resting on the pins 180, 182, 280 and 282. In this position, the longitudinal passage through the housing 200 is aligned coaxially with the axis of the hydrotube 140.

When it is time to remove the housing 200 from the apparatus 100, the handles 204 and 206 are grasped by the operator (as shown in FIG. 19) and tilted toward himself/herself, typically toward the chest or waist of an average-sized operator. This first movement rotates the housing 200 about its longitudinal axis, but may not move the housing 200 laterally. The chute 220 is mounted laterally of the cutter head zone 202 to permit the housing 200 to rest upon another support structure once the housing 200 is displaced laterally sufficiently to be removed from the pins 180, 182, 280 and 282. The configuration shown in

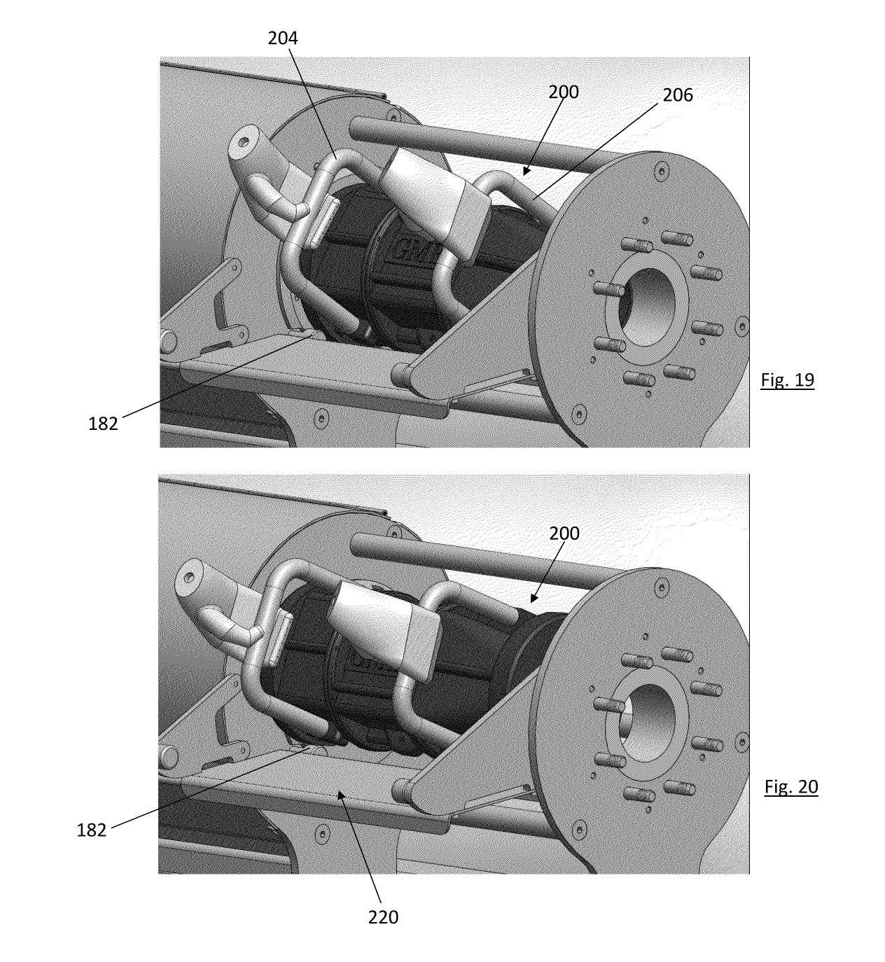

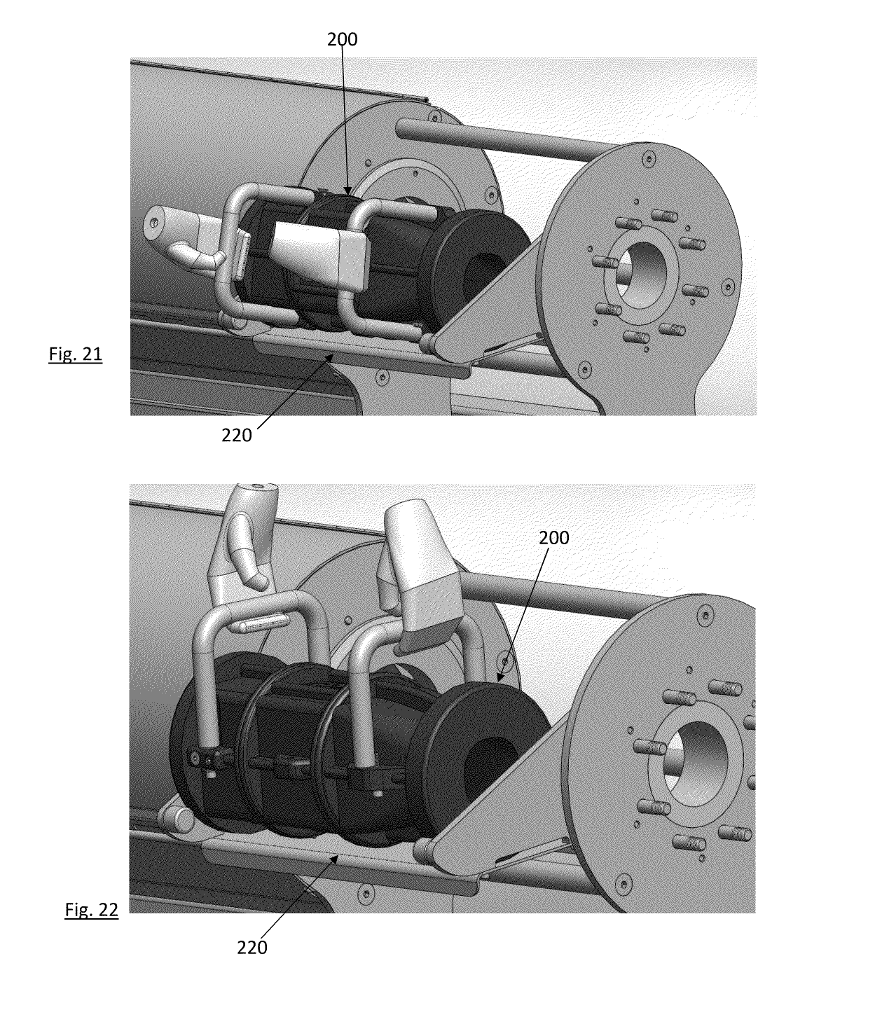

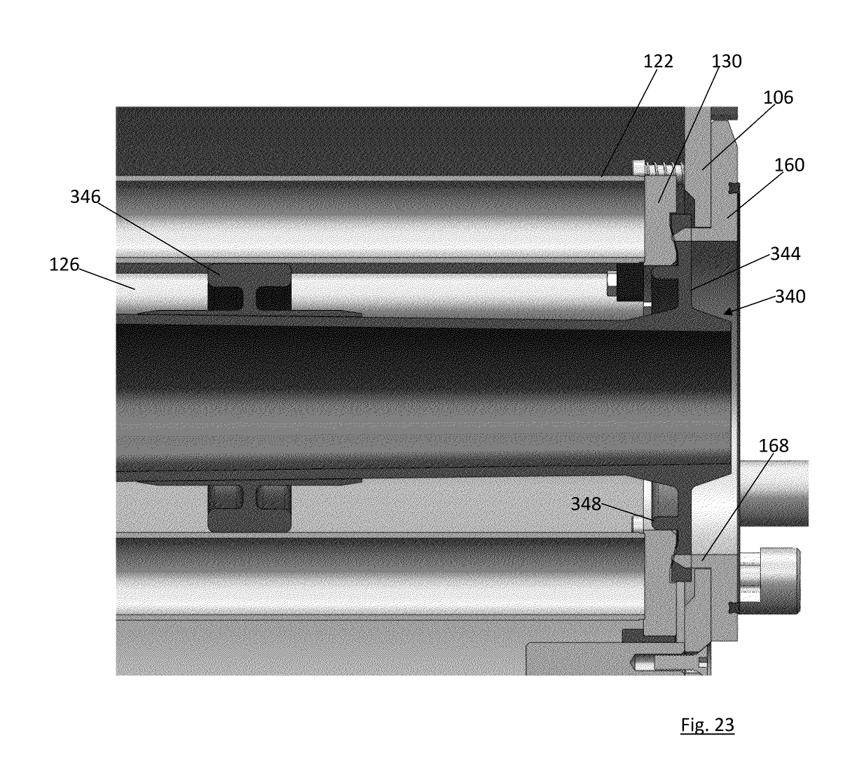

FIG. 20 is where the housing 200 is first pulled laterally from the FIG. 19 position. FIG. 21 shows the position of the housing 200 as the operator pulls the housing 200 further laterally to the end of the chute 220. Once the housing 200 is sufficiently far from the longitudinal axis of the apparatus 100, such as in the position on FIG. 21, it rests upon the chute 220 only and is closer to the center of mass of the operator than when in the operable position. The operator may then simply grasp and rotate the handles upwardly to the position shown in FIG. 22, permitting him or her to pick up and carry the housing 200 away from the apparatus 100.

Because of the configuration of the apparatus 100, the housing 200 may be displaced laterally of the central longitudinal axis of the apparatus 100 before the weight of the housing 200 must be born significantly by the operator. By lifting the housing 200 only once the housing 200 has reached the edge of the chute 220, the housing 200 is located in an ergonomically advantageous position for the operator to lift the housing 200.

In FIGS. 19 and 20, the pin 182 is visible while the housing 200 is still in substantially its operable position. FIG. 20 shows the housing 200 after being pulled slightly laterally of the axis of the apparatus 100, and FIG. 21 shows further lateral movement to the edge of the chute 220. FIG. 22 shows the housing at the far end of the chute 220 with the handles 204 and 206 rotated to the top for best manual removal by the operator.

In order to replace the housing, the steps above for removal are reversed and the housing 200 is placed in the cutter head housing zone 202 with the pins 180 and 182 located on opposite lower sides of the upstream end of the housing 200, and the pins 280 and 282 located on opposite lower sides of the downstream end of the housing 200. This configuration aligns the housing 200 on the central longitudinal axis of the apparatus 100 due to the position the housing 200 seeks under the influence of gravity once the housing is placed in the cutter head housing zone 202 resting on the pins 180, 182, 280 and 282.

When the housing 200 is in an operable position shown in FIG. 19, the downstream end of the seal transfer plate 160 may be spaced from the upstream face of the outlet plate 260 a distance slightly less or greater than the distance from the opposing longitudinal ends of the housing 200. The seal transfer plate 160 is biased to a slightly upstream position from its extreme downstream position by the coil springs around the bolts 162. The bias thus positions the seal transfer plate 160 at a distance from the outlet plate 260 that is close to the housing's 200 length. This configuration permits the operator to insert the housing 200 in the cutter head housing zone 202 between the downstream face of the seal transfer plate 160 and the upstream face of the outlet plate 260 without having to adjust the position of the seal transfer plate 160 to permit the housing 200 to fit in the cutter head housing zone 202. The housing 200 is gently inserted between the downstream face of the seal transfer plate 160 and the upstream face of the outlet plate 260 by the mass of the housing 200 moving the seal transfer plate 160 upstream slightly, if necessary, due to the wedging action of the housing 200 being placed on the chamfered edge of the seal transfer plate 160. The seal transfer plate 160 thus moves upstream from the position shown in FIG. 16 to the position shown in FIG. 17 when the housing 200 is inserted into the cutter head housing zone 202.

If, once the housing 200 is in the operable position shown in FIG. 19, the hydrotube 140 is in its operable position shown in FIGS. 6 and 7, the case 120 can be actuated to move longitudinally downstream. If the hydrotube 140 is not in the operable position, it is placed there and then the case 120 is moved. The hydrotube 140 is placed in the operable position by first moving the bars 122 and 124 to the open position and inserting the flange 142 in the gap between the compression plate 150 and the ring 132. The hydrotube 140 is shown just outside the case 120 in FIGS. 14 and 15. A gap is formed between the compression plate and the ring 132 due to the shoulder bolt 132s mounting the compression plate to the ring 132, and the upstream flange 142 is simply inserted into the gap formed. The downstream flange 144 is then inserted in the gap between the ring 130 and the plate 106 as shown in FIGS. 15 and 16. Insertion order of the flanges 142 and 144 may be reversed. Once the flanges 142 and 144 are in their respective gaps, the bars 122 and 124 and associated pivotable ring portions are pivoted to the closed positions and the safety shield 110 is closed. The operator may subsequently actuate the rams 170 and 172 to displace the compression plate 150 downstream from its starting, upstream position shown in FIGS. 10 and 12.

Upon actuation, the rams 170 and 172 displace the compression plate 150 in the downstream direction and the compression plate's 150 downstream face first abuts the upstream face of the upstream flange 142. Upon contacting the upstream flange 142, the flange 142 is compressed between the compression plate 150 and the ring 132 until the flange's 142 resistance to further compression overcomes the forces that resist downstream movement of the case 120. Once this occurs, the rams 170 and 172 begin to displace the case 120 and the enclosed hydrotube 140 in a downstream direction.

When the downstream movement of the case 120 begins, the downstream flange 144 of the hydrotube 140 is facing, and is spaced from, the plate 106 across a gap as shown in FIG. 16. This gap (shown in FIG. 16) permits the downstream end of the hydrotube 140 to be placed in the case 120 without having to manually insert the terminal end of the hydrotube 140 longitudinally through an aperture, as is common with prior art tubes and related apertures. The hydrotube 140 and the case 120 are normally displaced downstream only after the housing 200 is in the operable position in the cutter head housing zone 202, which will result in the seal transfer plate 160 being farther upstream than it is shown in FIG. 16. Nevertheless, FIG. 16 accurately shows the hydrotube 140 in the case 120.

The downstream face of the flange 144 reaches the sharp edge 168e of the annulus 168 as shown in FIG. 17, and any additional downstream movement by the rams 170 and 172 from the point shown in FIG. 17 causes compression of the flange 144 between the edge 168e and the ring 130. This compression occurs because the housing 200 (not shown in position in FIGS. 16 and 17) resists any further substantial movement of the seal transfer plate 160 downstream of the position shown in FIG. 17, even though downstream movement may be possible when the housing 200 is not in an operable position. This is due to the fact that when the housing 200 is positioned between the seal transfer plate 160 and the outlet plate 260, an essentially rigid body is thus placed between the plates 160 and 260. Nevertheless, the housing 200 has slightly compressible seals on the ends thereof that interface with the plates 160 and 260 to provide a complete seal between the plates 160 and 260 and the housing 200. Thus, as the rams 170 and 172 further displace the case 120 downstream from the position shown in FIG. 16 and then FIG. 17, the seal transfer plate 160 may be displaced slightly downstream from the position shown in FIG. 17 due to the slight compressibility of the housing 200 and its seals, which may be o-rings or quad rings. Nevertheless, the flange 144 is compressed sufficiently between the ring 130 and the edge 168e that it forms a seal.

It is a further advantage of the invention, as illustrated in FIG. 17, that the downstream flange 144 has a thick, peripheral rim 144r that is substantially thicker than the portion of the flange 144 radially inwardly of the rim 144r. The rim 144r may have an angled face 144f on the upstream side at the transition between the thicker rim 144r and the thinner, remainder of the flange 144. The angled face 144f of the flange 144 aligns with the angled face 130a on the downstream side of the ring 130, and the sharp edge 168e seats against the downstream side of the flange 144 in a radially similar position to the angled face 144f. The force applied by the edge 168e generates a radially-outwardly directed force on the flange 144 due to the contacting, angled faces 144f and 130a, thereby causing outward elongation of the flange 144 in all radial directions. This outward radial force on the flange 144 causes the flange 144 to find a central position, and thus aligns the flange 144 along the axis of the case 120 and hydrotube 140, which axes may be aligned with the central axis of the apparatus 100.

Upon significant compression of both flanges 142 and 144, the rams 170 and 172 continue displacing the case 120 downstream to compress the downstream face of the seal transfer plate 160 against the upstream face of the housing 200, and the downstream face of the housing against the upstream face of the outlet plate 260. Once the seals on the opposite ends of the housing 200 have compressed sufficiently, the rams 170 and 172 are displaced no further, which may be due to reaching maximum force or due to compression sensors and a programmed limit on the application of ram force. Regardless of the reason, the apparatus 100 is at this point in an operable state because all desired seals are effective through the length of the apparatus 100. Thus, food product suspended in water may be forced through the hydrotube 140 in a known manner, to be sliced by the cutter head in the housing 200, and then have the water and food product pieces flow out of the housing 200.

Removal of the housing 200 and hydrotube 140 occur by operation in the reverse of that described above. The force applied by the rams 170 and 172 is relieved and the case 120 is driven in the upstream direction. Upon reaching the compete upstream position, the bars 122 and 124 may be pivoted to the opened position, as shown in FIGS. 12, 14 and 15, and the hydrotube 140 may be removed from the case 120. Removal is accomplished by manually grasping the hydrotube 140 and pulling it away from the bars 126 and 128 to take the flanges 142 and 144 out of their respective gaps. Once the case 120 is in the upstream position, the housing 200 may be removed from the housing zone 202 following the description above associated with FIGS. 19-22.

The hydrotube 140 herein is “substantially flexible”, which means that the tube has flexibility characteristics of food grade rubber when manufactured with the wall thickness, length and other parameters shown and described, and used at typical operating temperatures of hydro-cutting systems. The hydrotube 140 is substantially flexible inasmuch as food products and water propelled through the hydrotube 140 impact the hydrotube 140 and cause the hydrotube 140 to deflect radially, thereby accommodating the food products' movement through the hydrotube 140, rather than substantially resisting such movement therethrough. Of course, the hydrotube 140 may be manufactured from other materials, including but not limited to urethane, natural rubber and others as will be recognized by persons of ordinary skill from the description herein.

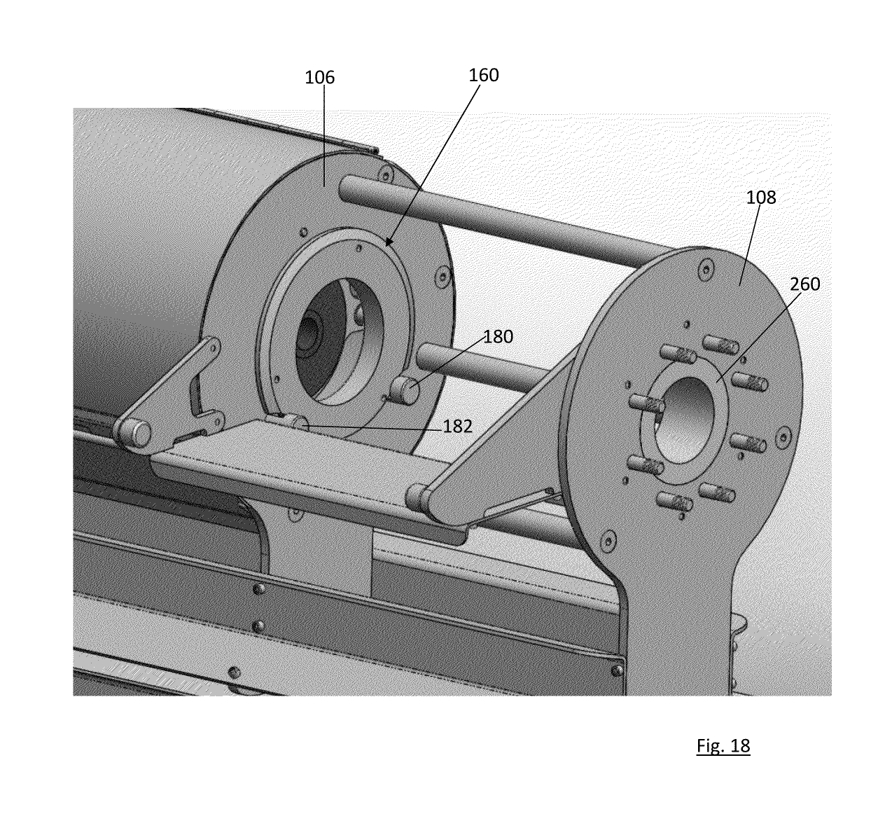

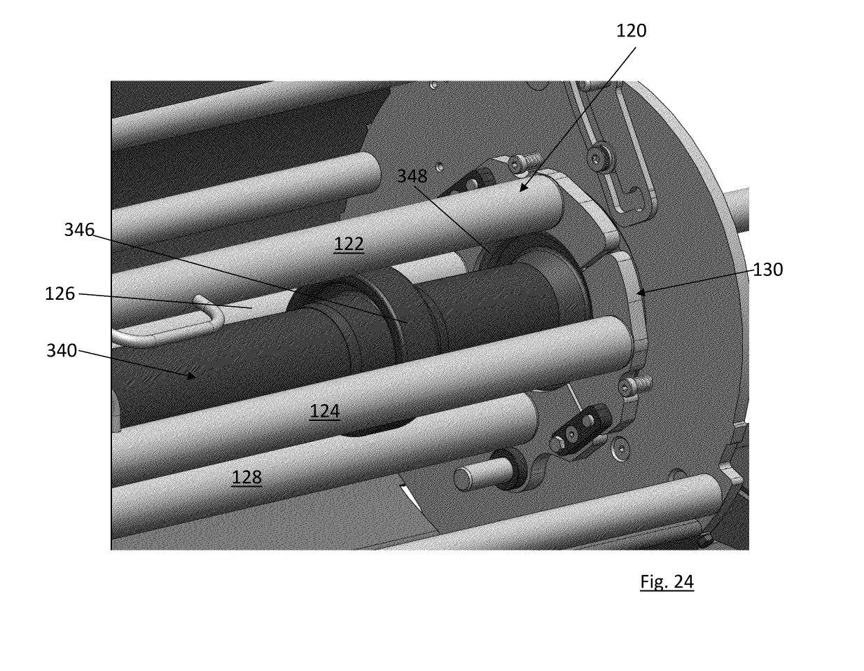

An alternative hydrotube 340 is shown in FIGS. 23 and 24 having a downstream flange 344 mounted adjacent the ring 130 of the case 120 in the same location where the flange 144 is described above and shown in FIGS. 2-22 being mounted. The flange 344 is substantially the same shape and size as the flange 144, with the exception that the flange 344 has an annular ring 348 that extends upstream from the flange 344 to a position just radially inwardly of the downstream ring 130. The annular ring 348 provides positive radial positioning of the flange 344 relative to the ring 130, because upon insertion of the flexible flange 344 in the gap, the annular ring 348 “seeks” the position shown in FIG. 23 due to substantial distortion of the flange 344 when the annular ring 348 is not in the position shown. When the operator manually inserts the flexible flange 344 into the gap between the ring 130 and the seal transfer plate 160, the annular ring 348 causes the flange 344 to be visibly misaligned in the gap until the operator places the annular ring 348 in the position shown. Once this occurs, there is a preliminary alignment with the case 120, and the case 120 may be displaced downstream as described above. This downstream displacement causes the flange 344 to be compressed between the ring 130 and the annulus 168 as described above for the flange 144, and this causes the flange 344 to be stretched radially outwardly due to the angled upstream face of the flange 344 seating against the angled downstream face of the ring 130.

During use, the length of the hydrotube 340 between the downstream flange 344 and the upstream flange (not shown, but substantially identical to the upstream flange 142) may be maintained substantially the same distance from the bars 122-128 by a stabilizer 346. The stabilizer 346 is an annular support against radially-directed forces having a radially inwardly facing surface 346i that seats against the hydrotube's 340 external surface and a radially outwardly facing surface 346t that seats against the bars 122-128 when the bars 122 and 124 are in the closed position as shown in FIGS. 23 and 24. The cross-section of the stabilizer 346 is similar to an I-beam, inasmuch as there is a larger outer rim, and a web that connects the outer rim to the inner band. The radial thickness of the stabilizer 346 may be substantially the same as the radial gap between the hydrotube 340 and the bars 122-128 when the hydrotube 340 is in a stable position. The stabilizer 346 may be separate, as shown, or integrated into the hydrotube 340, such as by welding or forming integral with the tapered sidewall of the hydrotube 340. If separate, the stabilizer 346 may be placed at any point along the hydrotube's 340 length, and may be about ten inches from the downstream flange 344.

It will be understood that the number of bars 122, 124, 126 and 128 may be modified from that shown and described. For example, a single member may extend from one ring to the opposite ring, and the relatively moveable case portion may not be a member that extends from one ring to the opposite. Nevertheless, this apparatus will retain the hydrotube and permit removal and insertion of the same by opening to the operator. It will also be understood that the number of prime movers may be increased or reduced, as may be the mounting locations thereof. Therefore, this detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for a hydraulic cutting system having a pump that propels solid food products suspended in a working liquid through a blade, the apparatus comprising:
(a) an elongated case mounted in, and longitudinally-movable relative to, a frame, the case having at least one rigid member connected to an upstream ring and extending to a connection to a downstream ring; and
(b) a substantially flexible, tapered tube mounted within, and substantially coaxially to, the case;
(c) wherein at least a first portion of the case is moveable from a closed position, in which the tapered tube is retained in the case, to an opened position, in which the tapered tube may be removed from the case, relative to a second portion of the case.

2. The apparatus in accordance with claim 1, wherein the tapered tube has at least a downstream flange against which the downstream ring seats, when compressed against a longitudinally-moveable seal transfer plate mounted in the frame, to form a seal.

3. The apparatus in accordance with claim 2, wherein the tapered tube has an upstream flange against which the upstream ring seats when compressed against a longitudinally-moveable compression plate that is mounted to the frame and drivingly linked to the case, to form a seal.

4. The apparatus in accordance with claim 3, further comprising at least one prime mover mounted to the frame and the compression plate for displacing the compression plate and the case downstream relative to the frame.

5. An improved hydraulic cutting system having a pump that propels solid food products suspended in liquid through a flexible, tapered tube and a blade, the improvement comprising:
(a) a rigid frame configured to receive a cutter head housing which contains the blade;
(b) an elongated case mounted in, and longitudinally-displaceable relative to, the rigid frame, the case having at least first, second and third rigid elongated members extending from an upstream ring to a downstream ring,
(i) the upstream ring including at least a first portion that is longitudinally displaceable relative to the frame, a second portion that is displaceable relative to the first portion, and a third portion that is displaceable relative to the first portion, wherein at least the first rigid member is mounted to the first portion, the second rigid member is mounted to the second portion, and the third rigid member is mounted to the third portion;
(ii) the downstream ring including at least a first portion that is longitudinally displaceable relative to the frame, a second portion that is displaceable relative to the first portion, and a third portion that is displaceable relative to the first portion, wherein at least the first rigid member is mounted to the first portion, the second rigid member is mounted to the second portion, and the third rigid member is mounted to the third portion;
(c) wherein the tapered tube is mounted within, and substantially coaxially to, the case, the tapered tube having at least a downstream flange against which the downstream ring seats to form a seal and an upstream flange against which the upstream ring seats to form a seal;
(d) a compression plate that is mounted, and longitudinally-moveable relative, to the frame and is drivingly linked to the upstream ring; and
(e) at least one prime mover mounted to the frame and the compression plate for displacing the compression plate, and the case, longitudinally.

6. The improved hydraulic cutting system in accordance with claim 5, wherein the first and second members and the first and second portions of each ring pivot from a closed position, in which the tapered tube is retained in the case, and an opened position in which the tapered tube is removable from the case.

7. The improved hydraulic cutting system in accordance with claim 6, wherein the tapered tube has at least a downstream flange against which the downstream ring seats, when the downstream flange is compressed against an upstream face of a longitudinally-moveable seal transfer plate mounted in the frame, to form a seal.

8. The improved hydraulic cutting system in accordance with claim 7, wherein the tapered tube has an upstream flange against which the upstream ring seats when compressed against the compression plate to form a seal.

9. The improved hydraulic cutting system in accordance with claim 8, wherein a downstream face of the seal transfer plate seats against an upstream face of the cutter head housing.
